(19) United States
(12) Patent Application Publication
(10) Pub. No.: US 2010/0162509 A1
(43) Pub. Date: Jul. 1, 2010

(54) Caulk bead compressing and smoothing tool

(76) Inventor: Eric Liao, Taichung (TW)

Correspondence Address: SAM CHEN, 7F-1, 293, ROOSEVELT ROAD, SEC 3, TAIPEI, TW

(21) Appl. No.: 12/346,904

(22) Filed: Dec. 31, 2008

(51) Int. Cl. B05C 17/10

(52) U.S. Cl. 15/235.7

(57) ABSTRACT

A tool for compressing and smoothing a bead of freshly applied fluent material in a joint at the intersection of two adjacent surfaces is provided. The tool includes a curved elongated handle comprising a front head, a friction section on an upper surface, a rear substantially vertical channel, a blade affixed to a front wall of the channel, and an extension projecting from the rear end; a flexible working member affixed to the head; and a flexible cap releasably secured onto the working member. Manipulation of the tool by hand by pressing the cap against a bead of freshly applied fluent material at the intersection of two adjacent surfaces while pulling causes the cap to flex to compress and smooth the bead.

### BACKGROUND OF THE INVENTION

1. Field of Invention

The invention relates to tools for compressing and smoothing beads of caulk, putty and other fluent materials, and more particularly to a tool for compressing and smoothing beads of fluent material freshly applied to a joint at the intersection of two adjacent surfaces (e.g., wall and floor).

2. Description of Related Art

A number of conventional tools are available to compress and smooth beads of fluent material freshly applied to a joint at the intersection of two adjacent surfaces. For example, U.S. Pat. No. 6,219,878 discloses a hand held tool for the uniform compressing, forming and simultaneous cleaning of a previously applied bead of caulking or other similar fluent material from a constructed joint. The tool includes an elongated handle and triangular head with working edges, the working edges being essentially an arrow-like shaped piece or rubber-like material fixed to and extending slightly beyond the acute isosceles triangular shaped head portion of the tool at the extremity opposite an elongated handle, the acute angle of the working edges at the extremity is slightly rounded. The head and the handle contain a continuous longitudinal channel provided for the collection of excess material gathered during the operation of the tool and in the preferred embodiment the head and handle are essentially molded as one unit in resilient plastic material with the handle expanding in a fan-like shape the outer angles of the head.

Thus, continuing improvements in the exploitation of caulk bead compressing and smoothing tool are constantly being sought.

### SUMMARY OF THE INVENTION

It is therefore one object of the invention to provide a tool for compressing and smoothing beads of fluent material freshly applied to a joint at the intersection of two adjacent surfaces.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of caulk bead compressing and smoothing tool according to the invention;

FIG. 2 is a view similar to FIG. 1 with the cap being removed;

FIG. 3 is a perspective view where the tool is applied against a bead of freshly applied fluent material in a joint at the intersection of two adjacent surfaces;

FIG. 4 is a side elevation of the tool in part section with the projecting mouth of a silicone paste tube being inserted into a handle channel; and

FIG. 5 is a view similar to FIG. 4 where a front portion of the projecting mouth of the tube has been cut out by the blade.

### DETAILED DESCRIPTION OF THE INVENTION

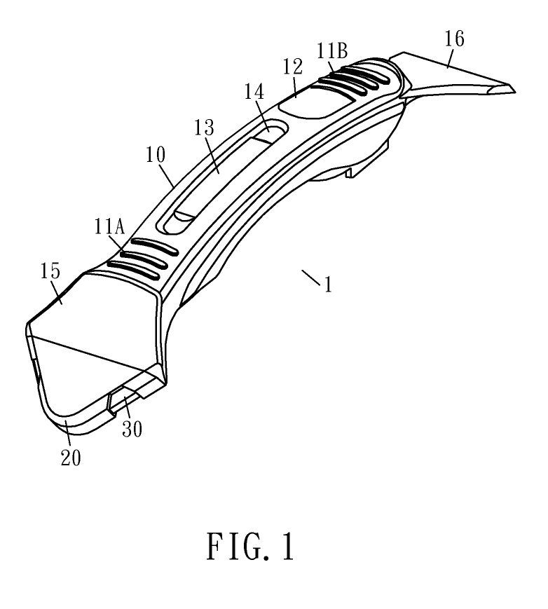

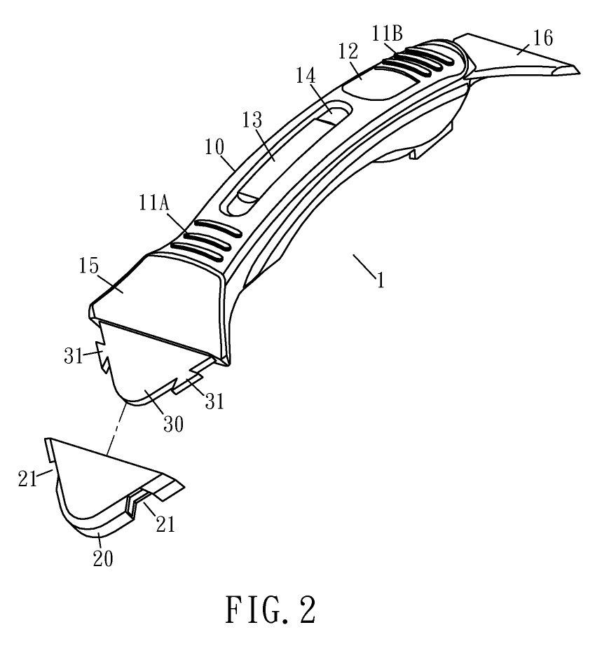

Referring to FIGS. 1 to 5, a caulk bead compressing and smoothing tool 1 in accordance with a preferred embodiment of the invention is shown. The tool 1 is slightly curved and comprises the following components as discussed in detail below.

An elongated handle 10 comprises an enlarged head 15 of truncated trapezoid with its front end being longer than its rear end and a downward oblique rear extension 16 having a straight rear edge. On upper surface of the body of the handle 10 (i.e., between and the head 15 and the rear extension 16) there are provided, from front to rear, a first ribbed section 11A, an elongated recess 14, a projection 13 formed in the recess 14, a blade 17 affixed to the front wall of the recess 14, a substantially vertical channel 12 open to top and bottom surfaces, and a second ribbed section 11B.

A flexible working member 30 formed of elastomeric material (e.g., plastic) is affixed to the front end of the head 15. The working member 30 is triangular and comprises two side tabs 31 of truncated trapezoid with its outer end being longer than its inner end.

A flexible cap 20 is also formed of elastomeric material (e.g., plastic) but is softer than the working member 30. The cap 30 is also triangular and comprises two side openings 21 of truncated trapezoid with its mouth being longer than its inner end. The tabs 31 and the openings 21 are matingly secured together when the cap 20 is put on the working member 30.

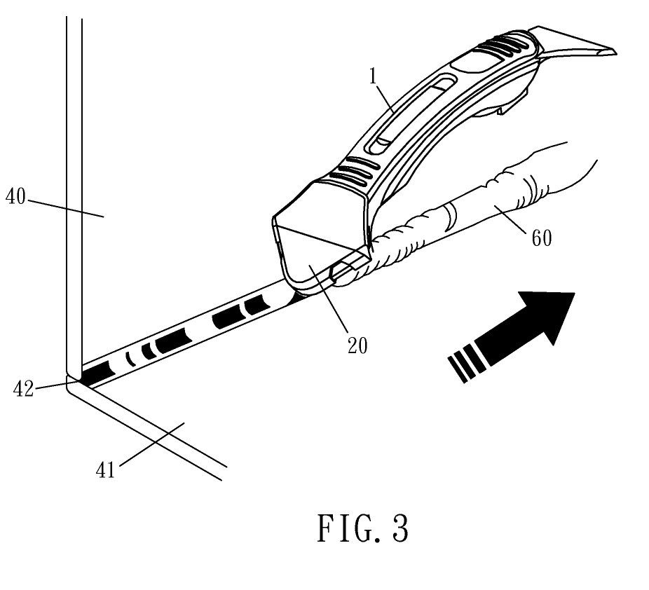

As shown in FIG. 3, the cap 20 is flexibly bent upward as it presses against a bead 60 of freshly applied fluent material (i.e., caulk) in a joint 42 at the intersection of a first surface 40 (e.g., a wall) and a second surface 41 (e.g., floor) perpendicular to the first surface 40. A user may pull the cap 20 rearward along the rough bead 60 with the cap 20 contacting both the surfaces 40, 41 so as to compress and the smooth the bead 60. As a result, the finished bead 60 has a concave surface.

The fluent material (i.e., caulk) is silicone in this embodiment.

The first and second ribbed sections 11A, 11B, the projection 13, the recess 14, and the curved handle 10 all can facilitate the holding of the handle 10 by the hand and the pulling operation of the tool 1.

It is noted that one of top surface, bottom surface, one side, and the other side of the cap 20 may be employed to do the compressing and smoothing operation. Further, the cap 20 may be replaced with a new one if it is no longer operable due to wearing.

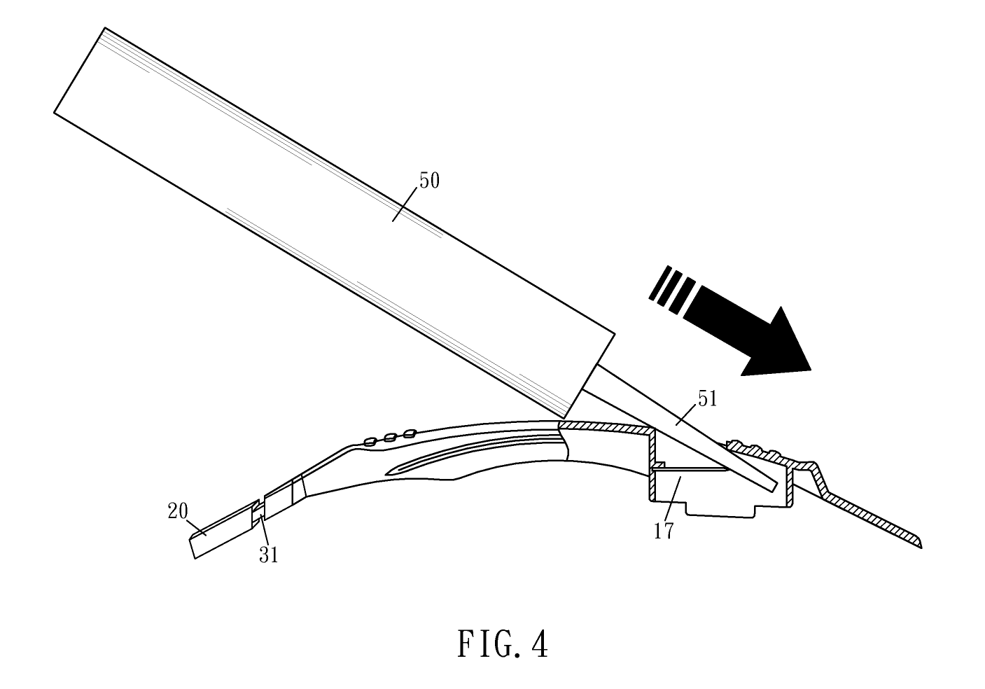

The rear extension 16 may be employed to smooth the finished beads of caulk 60. As shown in FIG. 4, either after or after the compressing and smoothing operation, a user may insert a projecting mouth 51 of a silicone paste tube 50 into the channel 12. Next, pivot the projecting mouth 51 against the blade 17 until the projecting mouth 51 is cut by the blade 17.

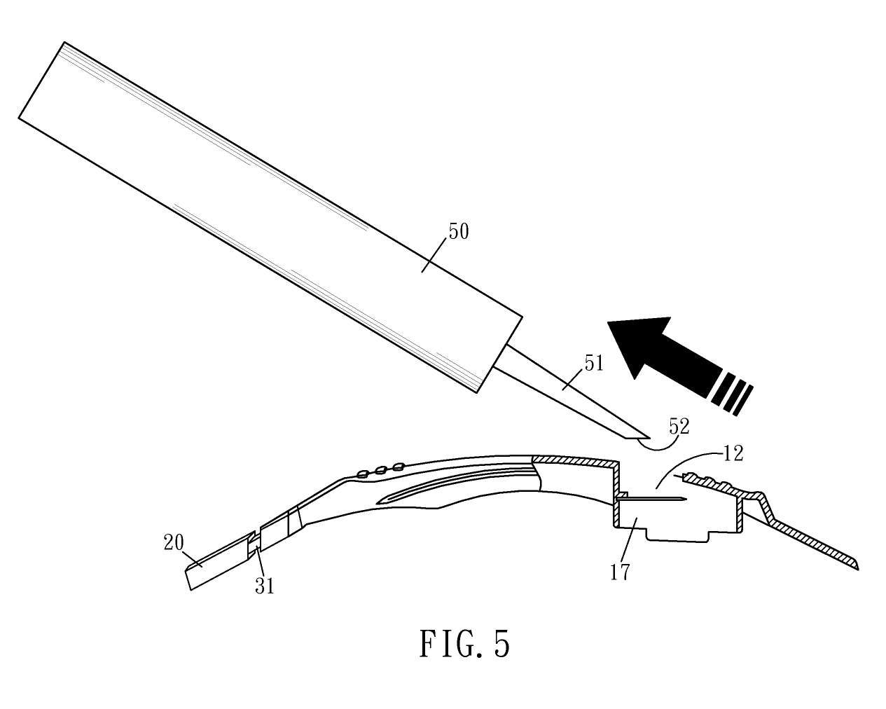

As shown in FIG. 5, thereafter the user may pull the silicone paste tube 50 out of the channel 12. It is shown that an oblique opening 52 is formed on the remaining portion of the projecting mouth 51. This cutting operation aims at facilitating the application of caulk from the projecting mouth 51 prior to the compressing and smoothing operation.

While the invention herein disclosed has been described by means of specific embodiments, numerous modifications and variations could be made thereto by those skilled in the art without departing from the scope and spirit of the invention set forth in the claims.

What is claimed is:

1. A tool for compressing and smoothing a bead of freshly applied fluent material in a joint at the intersection of two adjacent surfaces, comprising:
a curved elongated handle comprising a front head, a friction section on an upper surface, a rear substantially vertical channel, a blade affixed to a front wall of the channel, and an extension projecting from the rear end;
a flexible working member affixed to the head; and
a flexible cap releasably secured onto the working member,
whereby manipulation of the tool by hand by pressing the cap against a bead of freshly applied fluent material at the intersection of two adjacent surfaces while pulling causes the cap to flex to compress and smooth the bead.

2. The tool of claim 1, wherein the extension has a straight rear edge.

3. The tool of claim 1, wherein each of the working member and the cap is formed of elastomeric material but the cap is softer than the working member.

4. The tool of claim 1, wherein the working member is triangular and comprises two side tabs of truncated trapezoid, the cap is triangular and comprises two side openings of truncated trapezoid, and the tabs and the openings are matingly secured together when the cap is put on the working member.

5. The tool of claim 1, wherein the friction section comprises a first ribbed member adjacent the head of the handle, an elongated recess behind the first ribbed member, a projection in the recess, and a second ribbed member behind the channel.
